(19) United States
(12) Patent Application Publication
(10) Pub. No.: US 2017/0246964 A1
(43) Pub. Date: Aug. 31, 2017

(54) DEVICE UNIT

(71) Applicant: TOYOTA JIDOSHA KABUSHIKI KAISHA, Toyota-shi (JP)

(72) Inventors: Shuji KAWAMURA, Toyota-shi (JP); Ikuhiro NAKAMURA, Nisshin-shi (JP); Kozo MATSUURA, Toyota-shi (JP); Koji KATANO, Toyota-shi (JP); Tsutomu SHIRAKAWA, Toyota-shi (JP)

(73) Assignee: TOYOTA JIDOSHA KABUSHIKI KAISHA, Toyota-shi (JP)

(21) Appl. No.: 15/438,981

(22) Filed: Feb. 22, 2017

(30) Foreign Application Priority Data
Feb. 25, 2016 (JP) 2016-034484
Sep. 16, 2016 (JP) 2016-181759

(51) Int. Cl. B60L 11/18; H01M 8/04007

(52) U.S. Cl. CPC B60L 11/1892; H01M 8/04067; B60L 2210/14; B60L 2210/40; Y10S 903/908; H01M 2250/20

(57) ABSTRACT

A device unit is provided with a first heating element, a second heating element configured to generate a heat in an amount smaller than that generated by the first heating element, and a cooler located between the first heating element and the second heating element. The cooler has a coolant flow passage through which a coolant flows, and cooling fins disposed on a first heating element side in the coolant flow passage in a manner as to be substantially in parallel with a flow direction of the coolant, and a fluid resistance of the coolant in the coolant flow passage is smaller on a second heating element side than on the first heating element side.

### INCORPORATION BY REFERENCE

The disclosure of Japanese Patent Application No. 2016-181759 filed on Sep. 16, 2016 including the specification, drawings and abstract is incorporated herein by reference in its entirety.

### BACKGROUND

1. Technical Field

The present disclosure relates to a device unit.

2. Description of Related Art

Conventionally, it has been known that a device unit configured by stacking and unitizing multiple housings housing electric devices thereinside is installed in a vehicle (see Japanese Patent Application Publication No. 2005-323443, for example).

### SUMMARY

For example, if heating elements such as reactors and an inverter are stacked to be unitized, it may be considered that a cooler is disposed between these heating elements so as to reduce dimensions of the units, thereby promoting space saving.

However, these amounts of heat generated by these heating elements are different from each other so that the cooler disposed between the heating elements might sufficiently cool one side of the heating elements, but might not sufficiently cool the other side of the heating elements.

The present disclosure provides a device unit capable of promoting space saving, and preferably cooling multiple heating elements.

A device unit of an aspect of the present disclosure includes: a first heating element; a second heating element configured to generate a heat in an amount smaller than that generated by the first heating element; and a cooler located between the first heating element and the second heating element, wherein the cooler includes: a coolant flow passage through which a coolant flows; and cooling fins disposed on a first heating element side in the coolant flow passage in a manner as to be substantially in parallel with a flow direction of the coolant, and a fluid resistance of the coolant in the coolant flow passage is smaller on a second heating element side than on the first heating element side.

According to the device unit having this configuration, the device unit has the cooling fins on the first heating element side in the coolant flow passage, and thus it is possible to promote cooling efficiency of the first heating element. No cooling fins are provided on the second heating element side; therefore, resistance against the coolant flow on the second heating element side is smaller than resistance against the coolant flow on the first heating element side. Hence, a flow rate of the coolant on the second heating element side is faster than a flow rate of the coolant on the first heating element side, thus promoting the cooling efficiency of the second heating element. Through this, in the configuration having the heating elements on both sides of the cooler, even if the cooling fins are provided on only one side of the coolant flow passage, it is possible to enhance the cooling efficiency of both heating elements. Because the first heating element and the second heating element are cooled by the single cooler, it is possible to reduce the number of components, and it is also possible to minimize increase in height dimension that is the stacking direction of the device unit.

In the device unit of the above aspect, the cooling fins may have a wavy shape curved along the flow direction of the coolant.

According to the device unit having this configuration, by configuring the cooling fins into a curved shape along the flow direction of the coolant, it is possible to increase resistance that the coolant flowing along the cooling fins receives from the cooling fins. Through this, the coolant on the first heating element side is brought to flow into the second heating element side. Accordingly, the flow rate of the coolant flowing toward the second heating element side becomes faster, thus promoting cooling of the second heating element.

In the device unit of the above aspect, the cooler may have projections that are located on the second heating element side in the coolant flow passage, and project into the coolant flow passage.

According to the device unit having this configuration, it is possible to guide the coolant flowing through the coolant flow passage toward the first heating element side provided with the cooling fins by the projections on the second heating element side in the coolant flow passage in a manner as to project into the coolant flow passage. Accordingly, it is possible to enhance the cooling efficiency on the first heating element side generating a greater amount of heat.

In the device unit of the above aspect, the first heating element may consist of reactors, and the second heating element may be an inverter.

According to the device unit having this configuration, it is possible to promote space saving as well as to efficiently cool the reactors and the inverter that generate different amounts of heat by the common cooler.

According to the device unit of the above aspect, it is possible to provide a device unit capable of promoting space saving as well as preferably cooling multiple heating elements.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration view of a vehicle into which a device unit according to the present embodiment is installed;

FIG. 2 is a side view of the device unit according to the present embodiment;

FIG. 3 is a bottom view of the device unit according to the present embodiment;

FIG. 4 is a cross sectional view taken along line A-A in FIG. 2;

FIG. 5 is a cross sectional view taken along line B-B in FIG. 4; and

FIG. 6 is a cross sectional view taken along line A-A in FIG. 2 of the device unit according to a variation.

### DETAILED DESCRIPTION OF EMBODIMENTS

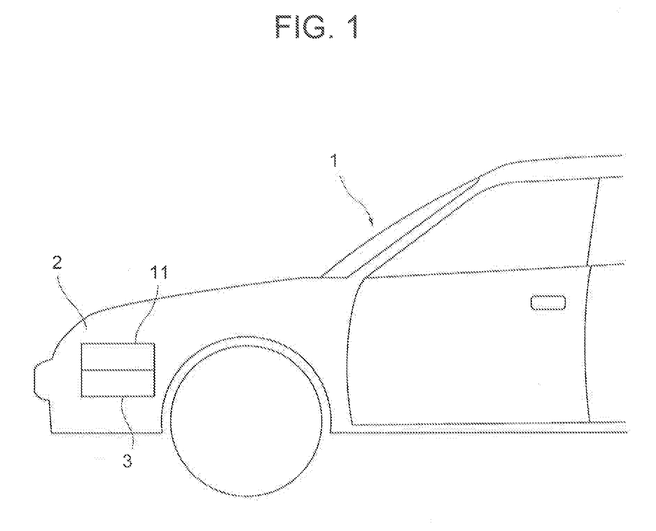

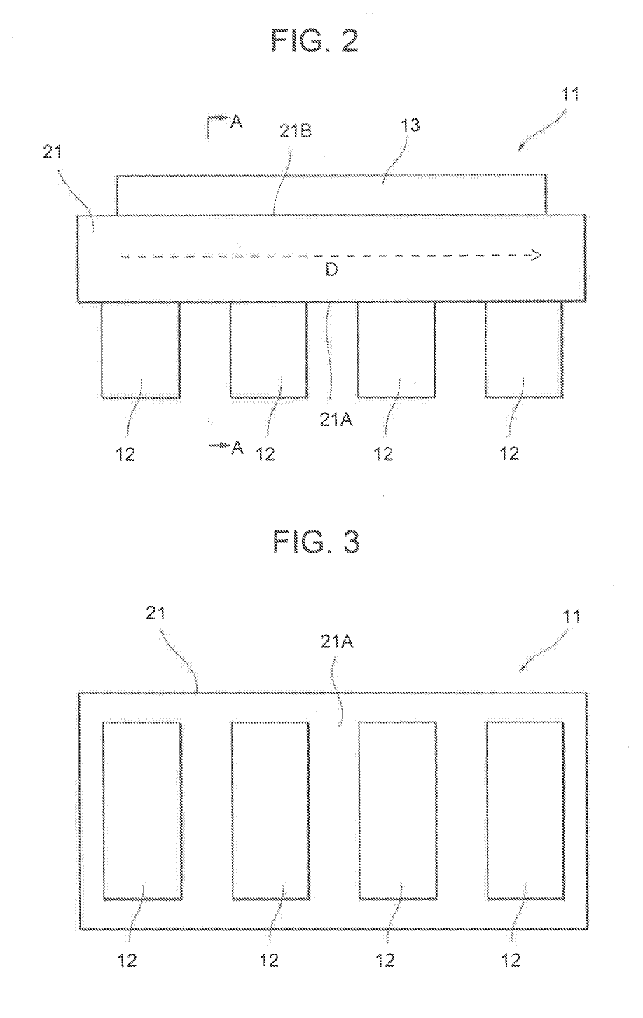

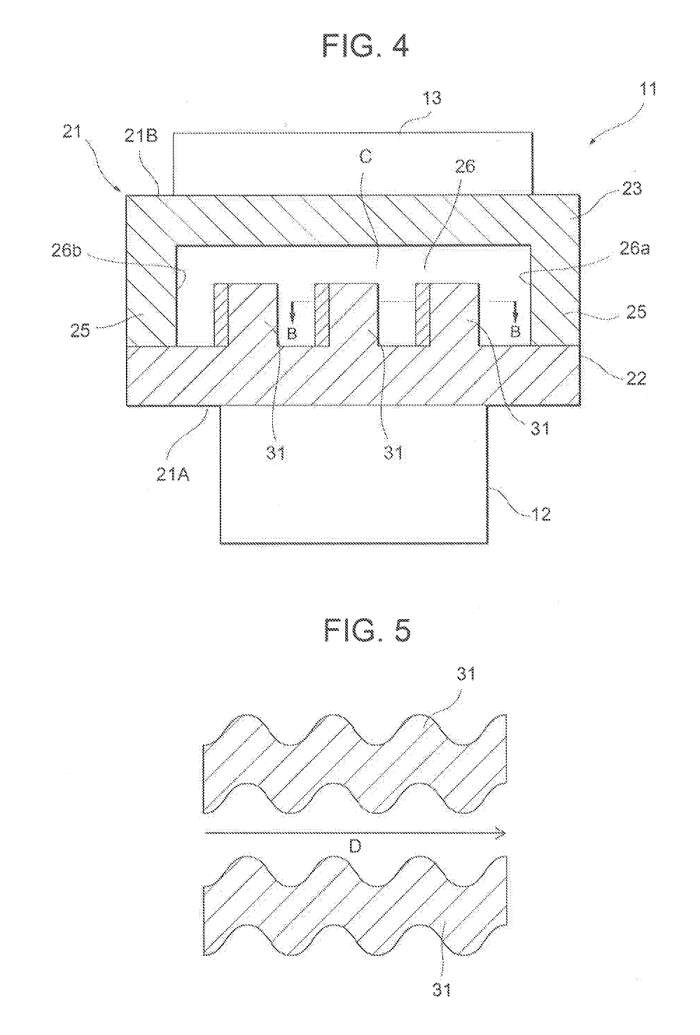

Hereinafter, an embodiment of a device unit according to the present disclosure will be described with reference to drawings. FIG. 1 is a schematic configuration view of a vehicle into which the device unit according to the present embodiment is installed. FIG. 2 is a side view of the device unit according to the present embodiment. FIG. 3 is a bottom view of the device unit according to the present embodiment, FIG. 4 is a cross sectional view taken along line A-A in FIG. 2. FIG. 5 is a cross sectional view taken along line B-B in FIG. 4.

As shown in FIG. 1, a vehicle 1 includes the device unit 11. The device unit 11 is housed inside an engine compartment 2 of the vehicle 1. The vehicle 1 in which the device unit 11 is installed is a hybrid vehicle traveling with driving force of an engine and a motor, or a fuel cell vehicle traveling by driving a motor with electric power generated by a fuel cell, or the like, for example. In the present embodiment, the case in which the device unit 11 is installed into a fuel cell vehicle will be described.

In the engine compartment 2 of the vehicle 1, a fuel cell 3 is installed, and the device unit 11 is a boost converter stacked on this fuel cell 3.

As shown in FIG. 2 and FIG. 3, the device unit 11 as the boost converter includes multiple reactors (first heating element) 12 for boosting, and an inverter (second heating element) 13 for a water pump and a hydrogen pump of the fuel cell 3. An amount of heat generated by the inverter 13 is smaller than an amount of heat generated by the reactors.

This device unit 11 includes a cooler 21. The cooler 21 is disposed between the reactors 12 and the inverter 13. The cooler 21 serves as a common cooler that cools both the reactors 12 and the inverter 13 that are attached thereto. One surface of the cooler 21 is configured to he a reactor-attachment surface 21A, and the other surface thereof is configured to be an inverter-attachment surface 21B. The multiple reactors 12 are attached to the reactor-attachment surface 21A of the cooler 21 with a distance between each two adjacent reactors 12. The inverter 13 is attached to the inverter-attachment surface 21B of the cooler 21.

As shown in FIG. 4, the cooler 21 includes a reactor-cooling member 22 and an inverter-cooling member 23, and the cooler 21 is configured by combining the reactor-cooling member 22 and the inverter-cooling member 23. The inverter-cooling member 23 has a peripheral wall 25 projecting from its periphery to the reactor-cooling member 22. The inverter-cooling member 23 is formed into a flat platy shape. The reactor-cooling member 22 and the inverter-cooling member 23 are combined so as to form a coolant flow passage 26 inside the cooler 21. Through the coolant flow passage 26, a coolant such as a cooling water flows in a direction D as shown in FIG. 2 and FIG. 5 (a direction in which the coolant flows. However, this direction may be inverse.).

The reactor-cooling member 22 is provided with cooling fins 31 arranged substantially in parallel with the coolant flow direction. The multiple cooling fins 31 are arranged with intervals in a width direction of the cooler 21 (width direction of the coolant flow) that is a direction orthogonal to the coolant flow direction. A clearance C is formed between front ends or the cooling fins 31 and the inverter-cooling member 23. As shown in FIG. 5, each cooling tin 31 is formed into a curved shape along the coolant flow direction, and the cooling fins 31 are arranged such that a wavy shape of the cooling fins 31 is continued along the coolant flow.

In the above-configured device unit 11 the reactors 12 and the inverter 13 are brought to generate heat by driving the fuel cell 3. The heats of the reactors 12 and the inverter 13 are respectively transferred to the cooler 21. Consequently, the reactors 12 and the inverter 13 are cooled.

At this time, in the cooler 21, the coolant flows through the coolant flow passage 26 in the direction D as shown in FIG. 2 and FIG. 5, thereby radiating the heats transferred from the reactors 12 and the inverter 13 via the coolant. The coolant flowing through the coolant flow passage 26 flows through the space between the cooling fins 31 provided on the reactor 12 side, and also through the clearance C. At this time, the coolant flowing along the cooling fins 31 having a curved shape along the coolant flow direction receives resistance from the cooling fins 31. To the contrary, on the inverter 13 side, the coolant flows through the clearance C provided between the cooling tins 31 and the inverter-cooling member 23 while receiving less resistance. Specifically, in the cooler 21, the cooling fins 31 are provided on the reactors 12 side in the coolant flow passage 26 so as to set the resistance against the coolant flow to be smaller on the inverter 13 side than on the reactor 12 side. As described above, the amount of heat generated by the inverter is smaller than that generated by the reactors 12. Through this configuration, it is possible to promote cooling of the reactors 12 generating a greater amount of heat by the cooling fins 31, and also to increase the flow rate of the coolant on the inverter 13 side more than on the reactor 12 side in the coolant flow passage 26, thereby promoting a total cooling efficiency. Accordingly, in the configuration that the heating elements generating different amounts of heat, consisting of the reactors 12 and the inverter 13 are provided on both sides of the cooler 21, even if the cooling fins 31 are disposed on only one side of the coolant flow passage 26, it is possible to enhance cooling efficiency of the heating elements of both the reactors 12 and the inverter 13.

The reactors 12 and the inverter 13 are cooled by the single cooler 21, and the cooling fins 31 are provided on only one side in the height direction of the coolant flow passage 26 of the cooler 21. Accordingly, it is possible to reduce the number of components, and also to suppress increase in height dimension that is the stacking direction of the device unit 11 as much as possible.

Specifically, in the case of forming the cooling fins on both sides (on the reactor 12 side and the inverter 13 side) of the coolant flow passage 26, grooves are formed between the fins; thus it is inevitable that a cross section of the flow passage of the coolant becomes greater as a whole, which causes problems such as reduction in flow rate, deterioration of fin-cooling performance, and increase in dimension of the cooler by the height of the fins. To the contrary, in the present embodiment, the inverter 13 side generating a smaller amount of heat is configured to be finless so as to reduce a cross-sectional area of the flow passage of the coolant and increase the flow rate of the coolant, thereby increasing a heat transfer coefficient, enhancing the cooling performance on the reactors 12 side, and promoting reduction in dimension of the cooler by elimination of the fins.

Therefore, according to the device unit 11 of the present embodiment, it is possible to preferably cool the multiple heating elements as well as to promote space saving so that the device unit 11 can be readily housed inside the engine compartment 2 of the vehicle 1. Because of reduction in dimension and weight, it is possible to lower the center of gravity in a state in which the device unit 11 is installed in the vehicle 1.

In addition, the cooling fins 31 are formed in a curved shape along the flow direction of the coolant, thereby increasing resistance received by the coolant flowing along the cooling fins 31 from the cooling fins 31. Accordingly, the flow rate of the coolant flowing on the inverter 13 side becomes faster, thereby promoting the cooling of the inverter 13.

A device unit according to a variation including the cooler 21 having another structure will be described, hereinafter.

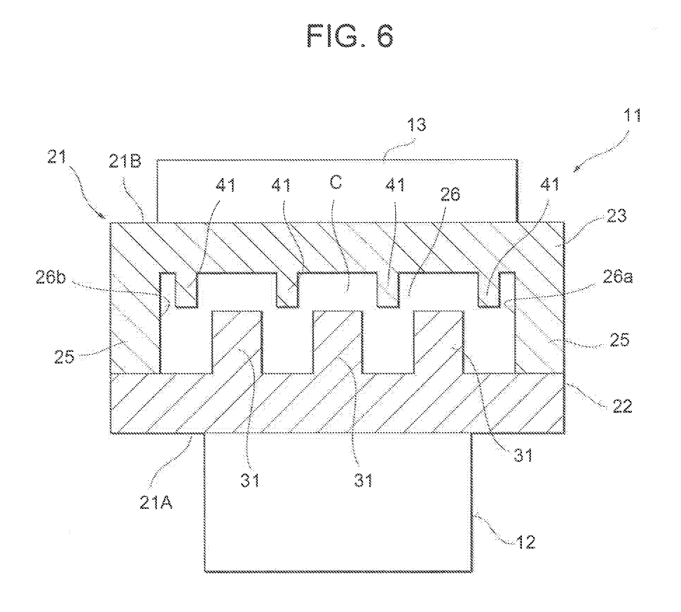

FIG. 6 is a cross sectional view taken along line A-A in FIG. 2 of the device unit according to the variation. As shown in FIG. 6, in this variation, the inverter 13 side in the coolant flow passage 26 of the cooler 21 is provided with multiple projections 41. These projections 41 are provided to the inverter-cooling member 23 such that these projections are arranged with intervals in the width direction of the coolant flow direction (the width direction of the cooler 21) between the cooling fins 31, and also between the cooling fins 31 and the peripheral wall 25. A length in the width direction vertical to the coolant flow (the width direction of the cooler 21) of each projection 41 is set to be smaller than a length in the width direction vertical to the coolant flow (the width direction of the cooler 21) of each cooling fin 31.

According to this variation, it is possible to guide the coolant flowing through the coolant flow passage 26 toward the reactors 12 provided with the cooling fins 31 by the projections 41 that project into the coolant flow passage 26 on the side of the inverter 13 that is the second heating element in the coolant flow passage 26. Through this, it is possible to enhance the cooling efficiency on the reactor 12 side generating a greater amount of heat.

What is claimed is:

1. A device unit comprising:
a first heating element;
a second heating element configured to generate a heat in an amount smaller than that generated by the first heating element; and
a cooler located between the first heating element and the second heating element, wherein
the cooler includes: a coolant flow passage through which a coolant flows; and cooling fins disposed on a first heating element side in the coolant flow passage in a manner as to he substantially in parallel with a flow direction of the coolant, and a fluid resistance of the coolant in the coolant flow passage is smaller on a second heating element side than on the first heating element side.

2. The device unit according to claim 1, wherein
the cooling fins have a wavy shape curved along the flow direction of the coolant.

3. The device unit according to claim 1, wherein
the cooler has projections that are located on the second heating element side in the coolant flow passage, and project into the coolant flow passage.

4. The device unit according to claim 1, wherein
the first heating element consists of reactors, and the second heating element is an inverter.
